(19) United States
(12) Patent Application Publication
(10) Pub. No.: US 2025/0014058 A1
(43) Pub. Date: Jan. 9, 2025

(54) HOTEL DEMAND EVALUATION METHOD AND HOTEL DEMAND EVALUATION SYSTEM WHERE A HOTEL DEMAND IS GENERATED ACCORDING TO VALID TEXTS PROCESSED USING MACHINE-LEARNING MODELS

(71) Applicant: DUN-QIAN Intelligent Technology Co., Ltd., Taichung City (TW)

(72) Inventors: Yen-Chu Chen, Chiayi City (TW); Ling-Jung Lin, Tainan City (TW); Shao-Chen Liu, Taichung City (TW); Hsuan-Wei Chen, Taichung City (TW); Shuh-Shian Tsai, New Taipei City (TW)

(21) Appl. No.: 18/507,117

(22) Filed: Nov. 13, 2023

(30) Foreign Application Priority Data
Jul. 7, 2023 (TW) 112125424

(51) Int. Cl. G06Q 30/0202; G06F 40/30; G06Q 30/0204

(52) U.S. Cl. CPC G06Q 30/0202; G06F 40/30; G06Q 30/0205

(57) ABSTRACT

A hotel demand evaluation method includes setting a plurality of keywords, collecting a plurality of texts according to the plurality of keywords, selecting a plurality of valid texts from the plurality of texts, performing a semantic analysis operation to identify at least one time keyword and at least one location keyword in the plurality of valid texts, generating a classification result according to at least the at least one time keyword and the at least one location keyword, classifying each valid text of the plurality of valid texts into a positive impact group, a no impact group or a negative impact group according to the classification result, and generating a hotel demand score of a specific region according to at least one valid text of the positive impact group and/or at least one valid text of the negative impact group.

### BACKGROUND OF THE INVENTION

### 1. Field of the Invention

The disclosure is related to a hotel demand evaluation method and a hotel demand evaluation system, and more particularly, a hotel demand evaluation method and a hotel demand evaluation system where a hotel demand is generated according to a plurality of valid texts processed using machine-learning models.

### 2. Description of the Prior Art

With the development of the travel industry, hotel management has become more and more complex. Traditionally, hotel operators or government agents predict tourism-related demand based on past statistics and personal experiences, so as to carry out relevant management.

However, this management method is not precise enough and inapplicable to manage hotels in response to latest tourism trends and news. Therefore, better solutions for assessing the hotel demand in a specific region are still in need in the field.

### SUMMARY OF THE INVENTION

An embodiment provides a hotel demand evaluation method including setting a plurality of keywords, collecting a plurality of texts according to the plurality of keywords, using a plurality of first classification models to select a plurality of valid texts from the plurality of texts, performing a semantic analysis operation to identify at least one time keyword and at least one location keyword in the plurality of valid texts, using a plurality of second classification models to generate a classification result according to at least the at least one time keyword and the at least one location keyword where the classification result is related to at least one travel period and at least one travel location corresponding to the plurality of valid texts, using a third classification model to classify each valid text of the plurality of valid texts into a positive impact group, a no impact group or a negative impact group according to the classification result, and generating a hotel demand score of a specific region according to at least one valid text of the positive impact group and/or at least one valid text of the negative impact group.

Another embodiment provides a hotel demand evaluation system. The hotel demand evaluation system includes a setting interface, a collection unit, a plurality of first classification models, a semantic analysis unit, a plurality of second classification models, a third classification model and a score unit. The setting interface is used to access a plurality of keywords. The collection unit is linked to the setting interface and used to collect a plurality of texts according to the plurality of keywords. The plurality of first classification models are linked to the collection unit and used to select a plurality of valid texts from the plurality of texts. The semantic analysis unit is linked to the plurality of first classification models and used to perform a semantic analysis operation to identify at least one time keyword and at least one location keyword in the plurality of valid texts. The plurality of second classification models are linked to the semantic analysis unit and used to generate a classification result according to at least the at least one time keyword and the at least one location keyword. The classification result is related to at least one travel period and at least one travel location corresponding to the plurality of valid texts. The third classification model is linked to the plurality of second classification models and used to classify each valid text of the plurality of valid texts into a positive impact group, a no impact group or a negative impact group according to the classification result. The score unit is linked to the third classification model and used to generate a hotel demand score of a specific region according to at least one valid text of the positive impact group and/or at least one valid text of the negative impact group.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a hotel demand evaluation method for a specific region according to an embodiment.

FIG. 2 illustrates the hotel demand evaluation system according to an embodiment.

FIG. 3 illustrates a flowchart of a hotel demand evaluation method according to an embodiment.

### DETAILED DESCRIPTION

In the text, when “and/or” is used to connect a plurality of objects, it can mean one, a portion, or all of the objects. When a plurality of objects are described to be “linked” with one another, it can mean the objects are linked with one another with a physical wired path and/or a wireless path. Here, a model can include a machine-learning neural network model implemented using software and/or hardware.

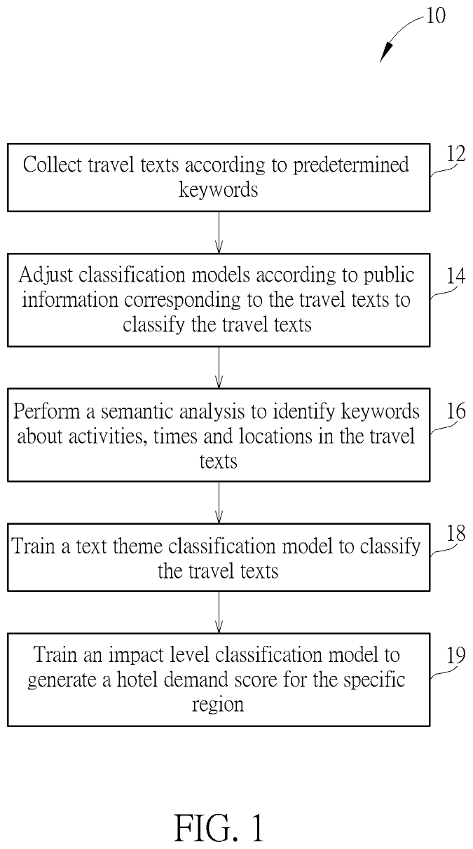

According to solutions of embodiments, a plurality of texts can be collected, and a hotel demand score of a specific region can be evaluated according to the texts. If the hotel demand score is higher, the hotel demand of the region can be higher. Hotel managers can adjust prices and allocate resources according to the hotel demand score. FIG. 1 illustrates a flowchart of a hotel demand evaluation method 10 for a specific region according to an embodiment. The hotel demand evaluation method 10 can include the following steps.
Step 12: collect travel texts according to predetermined keywords;
Step 14: adjust classification models according to public information corresponding to the travel texts to classify the travel texts;
Step 16: perform a semantic analysis to identify keywords about activities, times and locations in the travel texts;
Step 18: train a text theme classification model to classify the travel texts; and
Step 19: train an impact level classification model to generate a hotel demand score for the specific region.

In Step 12, a set of keywords can be used to collect texts from a plurality of sources. For example, the sources may include websites on the internet. In Step 14, the collected texts can be classified for the first time and marked (e.g. through automatic machine marking and/or manual marking) to filter out inapplicable texts. The texts which are impacting the hotel demand or will impact the hotel demand recently can be used as training data for training a machine learning model. A trained model can determine if the public information in a text can impact the hotel demand effectively, so as to filter out invalid texts to improve accuracy of calculating the hotel demand.

For example, some texts may be related to a long-term construction project with an inestimable completion date. Some texts may describe a past event which had an impact on the hotel demand, but the time of impact has passed. Some texts may include advertisement unrelated to the hotel demand. These texts can be invalid and filtered out.

In Step 14, a first round of text classification can be performed. After Step 14, the semantic analysis in Step 16 can identify effective keywords in the texts as features to identify time keywords and location keywords through an entity tagging technique. The entity tagging technique here can include a named entity recognition (NER) technique, and embodiments are not limited thereto. Other proper entity tagging techniques can be also used. The identified location keywords and time keywords in the selected texts can be used to determine (1) the regions related to the hotel demand corresponding to the texts, and (2) the impact time lengths of the texts after the texts are published. An impact time length can be obtained according to a combination of an event type, a location and a time keyword. For example, if an event is marked as a large sport event, the location is Taichung city, and the time keyword is March, an output result through combining the event keyword, the location keyword and the time keyword can indicate that the impact time may be one month before the event to the month of the event. Hence, an estimated impact time of the text (e.g. press release) may be February and March.

In Step 18, a second round of text classification can be performed. In the second round of text classification, a plurality of binary classification models can be used. The texts (e.g. press releases) after being marked can be training data, where the texts may be marked automatically by machine and/or manually. The models can be trained to determine the themes of the texts to output the theme(s) included in each text.

In Step 19, a third round of text classification can be performed. In the third round of text classification, a ternary classification model can be used for generating impact scores corresponding to different classification themes. For example, a plurality of theme classification models can be used to output data, and the outputted data can be inputted to the ternary classification models.

The ternary classification models can classify texts into three groups: a positive impact group, a no impact group and a negative impact group. Corresponding to different classification themes, when texts have a positive impact or a negative impact, the scores being added or subtracted can be different. Based on experiences or statistics, the scores can be determined according to how long and how much the hotel demand is impacted under a theme. For example, if a text (e.g. press release) includes a weather theme, the weather theme in the text has a weight of 5, and the impact score related to weather theme is 0 points in a no impact group, +3 points in a positive impact group, and −2 points in a negative impact group, when the press release is analyzed, the weight of the theme can be multiplied by the impact score of the corresponding group to generate the impact score of the text. For example, if the weight is 5, and the impact score is +3 points corresponding to a positive impact group, the impact score of the text can be 5×(+3), that is +15. As a result, a hotel demand score of a specific region in a time period can be summed up and generated according to the impacted region marked through entity tags.

For example, the classification models used in the flow of FIG. 1 can be related to an ordinal classification structure of three stages. In the first stage (e.g. Step 14), classification models (e.g. a plurality of binary models) can be used to determine if the public information in the texts are valid. In the second stage (e.g. Step 18), theme classification models (e.g. a plurality of binary models) can be used to classify the texts. In the third stage (e.g. Step 19), an impact level classification model (e.g. ternary classification model) can be used to determine how much the texts impact the hotel demand.

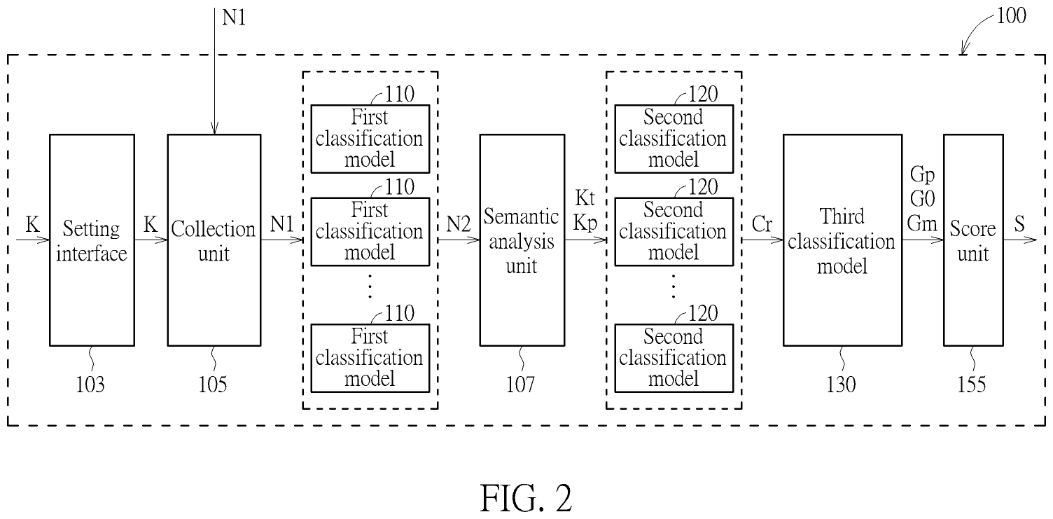

FIG. 1 describes a general process, and a hotel demand evaluation system 100 and a hotel demand evaluation method 300 with more details are described as below. FIG. 2 illustrates the hotel demand evaluation system 100 according to an embodiment. The hotel demand evaluation system 100 can include a setting interface 103, a collection unit 105, a plurality of first classification models 110, a semantic analysis unit 107, a plurality of second classification models 120, a third classification model 130 and a score unit 155.

In FIG. 2, the setting interface 103 and the collection unit 105 can be corresponding to Step 12 in FIG. 1. The plurality of first classification models 110 can be corresponding to Step 14 in FIG. 1. The semantic analysis unit 107 can be used in Step 16 in FIG. 1. The plurality of second classification models 120 can be used in Step 18 in FIG. 1. The third classification model 130 and a score unit 155 can be used in Step 19 in FIG. 1.

The setting interface 103 can be used to access a plurality of keywords K. The collection unit 105 can be linked to the setting interface 103 and used to collect a plurality of texts N1 according to the plurality of keywords K. The setting interface 103 can include a user interface and a data accessing interface.

For example, the collection unit 105 can be linked to the internet. The collection unit 105 can include software, hardware and/or firmware related to web crawlers and internet data access to crawl and collect the plurality of texts N1 from the internet.

According to another embodiment, the collection unit 105 can be linked to the internet and/or a database, and the collection unit 105 can include software, hardware and/or firmware related to internet data access to collect the plurality of texts N1.

For example, the texts N1 can include press released texts, texts from social websites, academic data texts, website texts, government data texts, unofficial database texts and/or other texts. The mentioned social websites can include Facebook, Instagram, Twitter (a.k.a. X), Reddit, Snapchat, TikTok and/or other social network websites.

The plurality of keywords K may be hotel-related keywords collected based on experience or statistics, or keywords automatically generated by a neural network based on a large amount of data. Therefore, the keywords K can be dynamically adjusted over time. For example, during the flower blossom season, the keywords K may include keywords related to flower blossom. In winter, the keywords K may include skiing-related keywords. Broadly speaking, the keywords K can include keywords related to sightseeing, tourism, attractions and leisure activities. In addition, from the tourism attractions marked by online travel agencies (OTAs), the attractions with a predetermined number of hotels marked by travel agencies (e.g. 10 hotels) can be selected as keywords. For example, non-attraction locations such as stations, supermarkets and universities may be filtered out optionally.

The plurality of first classification models 110 can be linked to the collection unit 105 and used to select a plurality of valid texts N2 from the plurality of texts N1. The first classification models 110 can be properly trained to enhance the ability of classification. The first classification models 110 can check the content of the texts N1 to filter out invalid texts. Since the sources of texts N1 are relatively wide and mixed, some texts may be related to construction news unrelated to hotels, and some texts may be expired news. For example, although a text had an impact on the hotel demand, the impact time has elapsed. Some texts may be advertisements unrelated to hotels. These invalid texts can be removed by the first classification models 110.

The semantic analysis unit 107 can be linked to the plurality of first classification models 110 and used to perform a semantic analysis operation to identify at least one time keyword Kt and at least one location keyword Kp in the valid texts N2. The keyword(s) Kt and the location keyword(s) Kp can be used to determine which region's hotel demand is impacted, and determine the length of time that the valid texts N2 impact the hotel demand.

The plurality of second classification models 120 can be linked to the semantic analysis unit 107 and used to generate a classification result Cr according to the at least one time keyword Kt and the at least one location keyword Kp. The classification result Cr can be related to at least one travel period and at least one travel location. Each classification model 120 can be corresponding to a theme for classifying each text of the valid texts N2 as being relevant or irrelevant to the theme.

The third classification model 130 can be linked to the plurality of second classification models 120 and used to classify each valid text of the plurality of valid texts N2 into a positive impact group Gp, a no impact group GO or a negative impact group Gm according to the classification result Cr.

The score unit 155 can be linked to the third classification model 130 and used to generate a hotel demand score S of a specific region according to at least one valid text in the positive impact group Gp and/or at least one valid text in the negative impact group Gm.

For example, if some press releases report that the weather in a hot spring area will be cold and sunny next week, and some press releases report a food festival of the hot spring area will be held next week, these press releases can be classified into the positive group Gp to increase the hotel demand score S in the hot spring area.

In another example, if some press releases report that the weather in a forest area will be rainy next week, and some press releases report that the roads in the forest area will be under construction next week, these press releases can be classified into the negative impact group Gm to decrease the hotel demand score S in the forest area.

The hotel demand evaluation system 100 can be used to perform classification of three stages. The setting interface 103, the collection unit 105 and the first classification models 110 can be used to perform classification of a first stage to check if a text is valid and select the valid texts N2. The semantic analysis unit 107 and the second classification models 120 can be used to perform classification of a second stage to classify the valid texts N2 with a plurality of themes. The third classification model 130 and the score unit 155 can be used perform classification of a third stage. In the third stage, the impact on the hotel demand of a specific region caused by the valid texts N2 of different themes can be evaluated to generate the hotel demand score S. For example, if the hotel demand score S is higher, the room rates can be raised, and the human resources and the management resources can be increased.

In FIG. 2, the first classification models 110 can include at least one first binary classification model. The second classification models 120 can include at least one second binary classification model. The third classification model 130 can include a ternary classification model.

For example, the first classification models 110 can include multi-layer classification models to perform a plurality of sorts of judgments, and the first classification models 110 can use a plurality of indexes to check if a text is an invalid expired text or an invalid advertisement.

The first classification models 110, the second classification models 120 and the third classification model 130 each can include a decision tree model, a random forest model, a support vector machine (SVM) model, an adaptive boosting (AdaBoost) model, an artificial neural network (ANN) model, a K nearest neighbor (KNN) model, a logistic regression model and/or a K-means model. The machine-learning models and algorithms mentioned here are examples, and embodiments are not limited thereto. The first classification models 110, the second classification models 120 and the third classification model 130 each can include one of the abovementioned models and algorithms, and other appropriate models and algorithms can be used. Each of the semantic unit 107 and the score unit 155 can include a neural network, and the neural network can be trained to perform related operations.

The binary classification model and ternary classification model described here can be classification models with machine learning, used to classify inputted data into different categories.

The main difference between a binary classification model and a ternary classification model is the number of classification categories. A binary classification model can classify data into two different categories, and a ternary classification model can classify data into three different categories.

A binary classification model can classify inputted data into two different categories. For example, a text can be classified as a valid text or an invalid text. An email can be classified as a spam or a normal mail. A binary classification model can be implemented using algorithms and machine-leaning models such as binary logistic regression, support vector machine, or random forest. A ternary classification model can classify the inputted data into three different categories. For example, a text can be classified as a text with positive impact, a text with no impact, or a text with negative impact. An image can be classified as a cat image, a dog image, or a bird image. A ternary classification model can be implemented using algorithm and machine-learning model such as multi-class logistic regression, decision trees or artificial neural networks.

In FIG. 2, the setting interface 103, the collection unit 105, the plurality of first classification models 110, the semantic analysis unit 107, the plurality of second classification models 120, the third classification model 130 and the score unit 155 can be integrated to the same hardware and/or the same software. The setting interface 103, the collection unit 105, the plurality of first classification models 110, the semantic analysis unit 107, the plurality of second classification models 120, the third classification model 130 and the score unit 155 can be implemented using hardware, software and/or firmware.

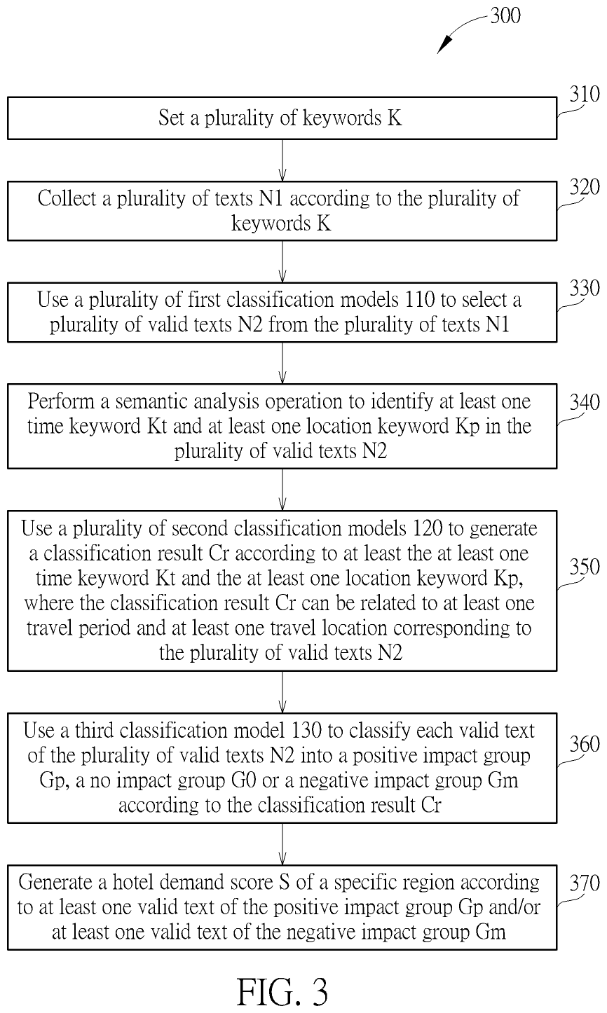

FIG. 3 illustrates a flowchart of a hotel demand evaluation method 300 according to an embodiment. The hotel demand evaluation method 300 can include the following steps.
Step 310: set a plurality of keywords K;
Step 320: collect a plurality of texts N1 according to the plurality of keywords K;
Step 330: use a plurality of first classification models 110 to select a plurality of valid texts N2 from the plurality of texts N1;
Step 340: perform a semantic analysis operation to identify at least one time keyword Kt and at least one location keyword Kp in the plurality of valid texts N2;
Step 350: use a plurality of second classification models 120 to generate a classification result Cr according to at least the at least one time keyword Kt and the at least one location keyword Kp, where the classification result Cr can be related to at least one travel period and at least one travel location corresponding to the plurality of valid texts N2;
Step 360: use a third classification model 130 to classify each valid text of the plurality of valid texts N2 into a positive impact group Gp, a no impact group GO or a negative impact group Gm according to the classification result Cr; and
Step 370: generate a hotel demand score S of a specific region according to at least one valid text of the positive impact group Gp and/or at least one valid text of the negative impact group Gm.

In FIG. 2 and FIG. 3, the setting interface 103 and the collection unit 105 can be used to perform Steps 310 and 320. The first classification models 110 can be used to perform Step 330. The semantic analysis unit 107 can be used to perform Step 340. The second classification models 120 can be used to perform Step 350. The third classification model 130 can be used to perform Step 360. The score unit 155 can be used to perform Step 370.

In Step 320, the texts N1 can be collected from the internet, databases and/or appropriate data sources according to the keywords K.

In Step 340, the semantic analysis operation can be performed to identify the time keyword Kt, the location keyword Kp and at least one travel keyword. In Step 350, the second classification models 120 can be used to generate the classification result Cr according to the time keyword Kt, the location keyword Kp and the travel keyword.

The semantic analysis operation in Step 340 can be described below. Semantic analysis can also be known as semantic understanding, which is an operation of natural language processing (NLP). The main purpose of semantic analysis is to analyze natural language through computer technology to understand the meaning and intention of natural language.

The following are several common types of semantic analysis. (1) Lexical semantic analysis: lexical semantic analysis can be performed to analyze words and the relationship between words in natural language, such as word meaning disambiguation, part-of-speech tagging, mining of relationships between words, etc. (2) Syntactic semantic analysis: syntactic semantic analysis can be performed to analyze the sentence structure and grammatical rules in a natural language to understand the meaning and relationship of each part of the sentence, such as syntactic analysis, semantic role annotation, etc. (3) Contextual semantic analysis: contextual semantic analysis can be performed to consider contextual information in a natural language, such as context, context information, etc., to infer the meaning and intention of the sentence, such as reference resolution, semantic association, etc. (4) Pragmatic semantic analysis: pragmatic semantic analysis can be performed to consider the purpose and intention of language actions, such as references, implications and inferences, etc., to identify and understand the intention and purpose in a natural language. The above semantic analysis methods can be used in combination according to requirements to improve the accuracy and efficiency of natural language processing. Neural networks can be trained and used to perform semantic analysis.

When using the semantic analysis unit 107 to perform abovementioned Step 16 and Step 340, semantic analysis can be performed to select important words in the valid texts N2. For example, the semantic analysis unit 107 can perform the following operations. (1) Word segmentation: a word segmentation system can be used to segment the text. (2) Stopword management: a stopword dictionary suitable for tourism texts can be generated, and stopwords that are commonly used in travel texts but not yet in the stopword dictionary can be added into the stopword dictionary. (3) Keyword extraction: algorithms such as Term Frequency-Inverted Document Frequency (TF-IDF) can be used to calculate the score of words to extract important keywords in travel texts and adjust weighted scores of different keywords according to requirements of hotel industry. (4) Sentiment analysis: sentiment analysis can be performed for texts to generate the scores corresponding to various effective emotional categories in the texts, observe which emotional categories have greater impact on the hotel demand, and adjust weights of the texts according to the impact where the weights are used for subsequent classification and scoring. Neural networks can be trained and used to perform semantic analysis.

When the score unit 155 is used to perform Step 370, based on the extracted keywords and score determined by sentiment analysis, weighted scores of travel texts of various categories can be evaluated, and the weighted scores can be converted to generate the hotel demand score S. The standards and results of evaluating scores can be compared with the statistics of the hotel industry from the open data of the tourism department, and the neural network can be adjusted accordingly to improve the accuracy of the hotel demand evaluation system 100.

In Steps 360 and 370, a positive score corresponding to a valid text of the positive impact group Gp can be positively related to an impact time length and an impact value of a travel keyword of the valid text. For example, if the valid text mentions a food festival is held from October 1 to October 15, the impact time length can be evaluated as 15 days, and the impact value can be generated according to the content of the valid text to adjust the hotel demand score S accordingly.

In Steps 360 and 370, a negative score corresponding to a valid text of the negative impact group Gm can be positively related to an impact time length and an impact value of a travel keyword of the valid text. For example, if the valid text mentions that a natural disaster occurred in a scenic spot, and the scenic spot will be closed from January 1 to January 16, the impact time length can be evaluated as 16 days. The impact value can be generated according to the content of the valid text to adjust the hotel demand score S accordingly.

In summary, through the hotel demand evaluation method 10 for a specific region, the hotel demand evaluation system 100 and the hotel demand evaluation method 300, the texts on the internet can be analyzed, the semantic analysis and the classification can be performed, and the hotel demand score S can be generated accordingly. The hotel demand score S is helpful for users to manage a hotel more accurately and promptly. The models used in FIG. 1 to FIG. 3 can be machine-learning neural network models, which can be trained and adjusted to improve the accuracy of classification and evaluation. As a result, the hardware resource, software resource and human resource are reduced, and the profit is increased. For hotel industry, a long-term difficulty is resolved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A hotel demand evaluation method comprising:
setting a plurality of keywords;
collecting a plurality of texts according to the plurality of keywords;
using a plurality of first classification models to select a plurality of valid texts from the plurality of texts;
performing a semantic analysis operation to identify at least one time keyword and at least one location keyword in the plurality of valid texts;
using a plurality of second classification models to generate a classification result according to at least the at least one time keyword and the at least one location keyword, wherein the classification result is related to at least one travel period and at least one travel location corresponding to the plurality of valid texts;
using a third classification model to classify each valid text of the plurality of valid texts into a positive impact group, a no impact group or a negative impact group according to the classification result; and
generating a hotel demand score of a specific region according to at least one valid text of the positive impact group and/or at least one valid text of the negative impact group.

2. The method of claim 1, wherein the plurality of first classification models comprise a first binary classification model.

3. The method of claim 1, wherein the plurality of second classification models comprise a second binary classification model.

4. The method of claim 1, wherein the third classification model comprises a ternary classification model.

5. The method of claim 1, wherein:
the semantic analysis operation is performed to further identify at least one travel keyword; and
the plurality of second classification models are used to generate the classification result according to the at least one time keyword, the at least one location keyword and the at least one travel keyword.

6. The method of claim 1, wherein a positive score corresponding to a valid text of the positive impact group is positively related to an impact time length and an impact value of a travel keyword of the valid text.

7. The method of claim 1, wherein a negative score corresponding to a valid text of the negative impact group is positively related to an impact time length and an impact value of a travel keyword of the valid text.

8. A hotel demand evaluation system comprising:
a setting interface configured to access a plurality of keywords;
a collection unit linked to the setting interface and configured to collect a plurality of texts according to the plurality of keywords;
a plurality of first classification models linked to the collection unit and configured to select a plurality of valid texts from the plurality of texts;
a semantic analysis unit linked to the plurality of first classification models and configured to perform a semantic analysis operation to identify at least one time keyword and at least one location keyword in the plurality of valid texts;
a plurality of second classification models linked to the semantic analysis unit and configured to generate a classification result according to at least the at least one time keyword and the at least one location keyword, wherein the classification result is related to at least one travel period and at least one travel location corresponding to the plurality of valid texts;
a third classification model linked to the plurality of second classification models and configured to classify each valid text of the plurality of valid texts into a positive impact group, a no impact group or a negative impact group according to the classification result; and
a score unit linked to the third classification model and configured to generate a hotel demand score of a specific region according to at least one valid text of the positive impact group and/or at least one valid text of the negative impact group.

9. The system of claim 8, wherein the plurality of first classification models comprise at least one first binary classification model, the plurality of second classification models comprise at least one second binary classification model, and the third classification model comprises a ternary classification model.

10. The system of claim 8, wherein the plurality of first classification models, the plurality of second classification models or the third classification model comprises a decision tree model, a random forest model, a support vector machine (SVM) model, an adaptive boosting (AdaBoost) model, an artificial neural network (ANN) model, a K nearest neighbor (KNN) model, a logistic regression model and/or a K-means model.
